(19) United States
(12) Patent Application Publication
(10) Pub. No.: US 2009/0058292 A1
(43) Pub. Date: Mar. 5, 2009

(54) FLAT PANEL DISPLAY AND FABRICATING METHOD THEREOF

(76) Inventors: Won-Hoe KOO, Suwon-si (KR); Hoon Kim, Hwaseong-si (KR); Jin-Koo Chung, Suwon-si (KR)

Correspondence Address: MACPHERSON KWOK CHEN & HEID LLP, 2033 GATEWAY PLACE, SUITE 400, SAN JOSE, CA, 95110, US

(21) Appl. No.: 12/144,505

(22) Filed: Jun. 23, 2008

(30) Foreign Application Priority Data
Aug. 27, 2007 (KR) 10-2007-0086108

(51) Int. Cl. H01J 1/62; H01J 9/02

(52) U.S. Cl. 313/512; 445/25

(57) ABSTRACT

A method of manufacturing a flat panel display includes preparing a cover substrate, forming a frit along an edge of the cover substrate, irradiating a first laser to the cover substrate, aligning and combining the cover substrate with the insulating substrate, the insulating substrate having a display element, and irradiating a second laser to the frit interposed between the cover substrate and the insulating substrate. Thus, the present invention provides a flat panel display that can minimize inflow of moisture and hydroxyl from the frit to the display element during the joining process of the insulating substrate and the cover substrate.

This application claims priority to Korean Patent Application No. 10-2007-0086108, filed on Aug. 27, 2007, the disclosure of which is hereby incorporated herein by reference in its entirety for all purposes.

### BACKGROUND OF THE INVENTION

(a) Field of the Invention

The present invention relates to a flat panel display and a fabricating method thereof, and more particularly, to a flat panel display that include reflective film, thereby improving optical efficiency and a fabricating method thereof.

(b) Description of the Related Art

Among flat panel displays, an organic light emitting display (“OLED”) has some advantages because it is driven with a low voltage, is thin and light, has a wide viewing angle, has a relatively short response time, etc. The OLED includes a thin film transistor (“TFT”) having a control electrode, a input electrode and a output electrode. The OLED also includes a pixel electrode connected to the TFT, a partition wall dividing the pixel electrodes from each other, an organic light emitting element formed on the pixel electrode between the partition walls, and a common electrode formed on the organic light emitting element.

The organic light emitting element includes a light emitting layer to represent at least one color of white, red, green, or blue. The organic light emitting element can further include at least one of a hole injecting layer, a hole transporting layer, an electron transporting layer, or an electron injecting layer.

The OLED can be categorized into bottom emission type and top emission type according to light emission direction. Light emits through a substrate having the TFTs in the bottom emission type. Thus, an aperture ratio is likely to decrease due to the TFTs and wire lines in the bottom emission type. On the other hand, light emitted from the light emitting layer emits through the common electrode. Thus, there is no decrease of the aspect ratio due to the TFTs.

Here, the organic light emitting layer is made of organic material which is susceptible to moisture and oxygen. Therefore, the performance and the lifespan of the organic light emitting layer are likely to be decreased by moisture and oxygen.

### BRIEF SUMMARY OF THE INVENTION

To prevent the organic light emitting layer from deteriorating, an insulation substrate is provided with a display element having the organic light emitting layer encapsulated with a cover substrate for blocking moisture and oxygen. Further, a frit is formed along an edge between the two substrates, thereby joining the two substrates together. However, the frit is susceptible to moisture and includes moisture and hydroxyl. The moisture and hydroxyl can be emitted during the encapsulation process of two substrates, thereby contaminating display elements having an organic material and causing the organic light emitting display to degrade.

Embodiments of the present invention provide a flat panel display that can minimize inflow of moisture and hydroxyl from the frit to a display element.

Another aspect of the present invention provides a method of fabricating a flat panel display that can minimize inflow of moisture and hydroxyl from the frit to a display element.

According to exemplary embodiments of the present invention, a method of manufacturing a flat panel display includes preparing a cover substrate, forming a frit along an edge of the cover substrate, irradiating a first laser to the cover substrate, aligning the cover substrate with an insulating substrate, the insulating substrate having a display element, and irradiating a second laser to the frit interposed between the cover substrate and the insulating substrate.

The forming of the frit further includes forming a frit paste by mixing a binder and a solvent with the frit, forming the frit paste along the edge of the cover substrate, removing the solvent, and removing the binder.

The frit paste can be formed by a dispensing method, a screen printing method, or slit coating method. The removing of the solvent is characterized with heating the frit paste to about 150° C. to about 200° C. for about 10 to 20 min. The removing of the binder is characterized with heating the frit paste to about 400° C. to about 500° C. for about 90 min to 150 min.

The first irradiation of the laser is characterized with irradiating the laser to the cover substrate corresponding to the area where the frit is formed. The first laser can be irradiated in the atmosphere of an inert gas such as nitrogen gas (N2) and argon gas (Ar), or in a vacuum.

A sealant can be formed along the outside of the frit before the aligning of the cover substrate and the insulating substrate.

The second laser can be irradiated to the cover substrate through a laser mask. The laser mask includes a transmissive part and a non-transmissive part. The width of the transmissive part is no bigger than the width of the frit. The second laser intensity per unit area of the second laser can be stronger than the first laser intensity.

According to exemplary embodiments of the present invention, a flat panel display includes an insulating substrate having a display element disposed thereon, a cover substrate facing and joined with the insulating substrate, and a frit interposed along an edge between the insulating substrate and the cover substrate, a frit surface facing the insulating substrate and having a first area in contact with the insulating substrate and a second area in no contact with the insulating substrate. The frit surface has a convex shape.

The second area is in the outside of the first area.

A sealant can be formed outside of the frit. The height of the sealant is substantially same as the height of the frit.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a perspective view illustrating a structure of an exemplary flat panel display according to an exemplary embodiment of the present invention;

FIG. 2 is a sectional view of the exemplary flat panel display, taken along line II-II in FIG. 1;

FIGS. 3 to 10 illustrate a method of manufacturing a flat panel display according to an exemplary embodiment of the present invention; and,

FIG. 11 is an enlarged detail view of the portion encircled by the dashed line “E” of FIG. 10.

Use of the same reference symbols in different figures indicates similar or identical items.

### DETAILED DESCRIPTION OF THE INVENTION

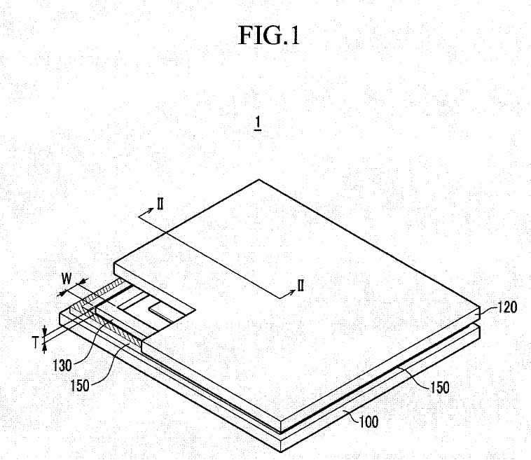

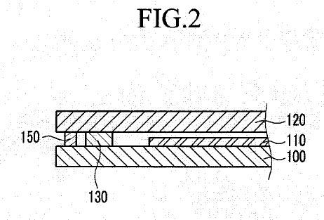

FIG. 1 is a perspective view illustrating a structure of an exemplary flat panel display according to an exemplary embodiment of the present invention, and FIG. 2 is a sectional view of the exemplary flat panel display, taken along line II-II in FIG. 1. An OLED 1 includes an organic light emitting layer that receives an electric signal and emits light by itself. Such an organic light emitting layer is susceptible to moisture and oxygen. Therefore, an encapsulating method can be employed to effectively prevent oxygen and moisture from permeating into the organic light emitting layer.

Referring to FIGS. 1 and 2, an OLED 1 according to an exemplary embodiment of the present invention includes an insulating substrate 100, a cover substrate 120, a frit 130, and a sealant 150. The insulating substrate 100 has a display element 110 to display an image. The cover substrate 120 faces and joins with the insulating substrate 100, thereby preventing oxygen or moisture from being introduced into the display element 110. The frit 130 is formed along an edge between the insulating substrate 100 and the cover substrate 120. The sealant is formed along the outside of the frit 130. The insulating substrate 100 is transparent, and may include a glass substrate or a plastic substrate.

The frit 130 in other embodiments of the invention is a frit means for minimizing exposure of the display elements from outside contaminants. The frit means is formed along an edge between the insulating substrate 100 and the cover substrate 120. The insulating substrate 100 is transparent, and may include a glass substrate or a plastic substrate.

Further, a barrier layer (not shown) may be formed on the insulating substrate 100 to protect the display element 110. The barrier layer can be formed of an organic layer, inorganic layer, or a composite layer thereof. In one embodiment, the barrier can include silicon oxynitride (SiON), silicon oxide (SiO₂), silicon nitride (SiNx), or aluminum oxide (Al₂O₃). The display element 110 can be provided by a well-known method. Further, the display element 110 includes a thin film transistor (“TFT”) having a gate electrode, a source electrode, and a drain electrode. The display element 110 further includes a pixel electrode connected to the TFT, a partition wall dividing the pixel electrodes from each other, an organic light emitting layer formed on the pixel electrode between the partition walls, and a common electrode formed on the organic light emitting layer. The display element 110 displays an image corresponding to a video signal outputted from an information processor. Although a particular embodiment of the display element 110 is described, other features of the display element 110 may also be incorporated.

The cover substrate 120 may be made of the same material as the insulating substrate 100. For example, the cover substrate 120 may include a soda-lime glass substrate, a boro-silicate glass substrate, a silicate glass substrate, a lead glass substrate, etc. The cover substrate 120 can have a thickness of 0.1 mm through 10 mm, thereby preventing moisture and oxygen from being permeated into the display element 110 through the cover substrate 120.

The frit 130 is formed along the edge between the insulating substrate 100 and the cover substrate 120. The frit 130 is formed on a non-display region of the OLED 1. The frit 130 prevents oxygen or moisture from being introduced through a gap between the insulating substrate 100 and the cover substrate 120. The frit 130 has a width W of 0.1 mm through 5 mm, and a thickness T of 1 μm through 3 mm. If the width W of the frit 130 is smaller than 0.1 mm, then a joining strength between the two substrates 100 and 120 would be deteriorated and defective. It would also be difficult to apply a dispensing method, a screen-printing method or a slit coating method to form the frit 130 if the width d1 of the frit 130 is smaller than 0.1 mm. On the other hand, if the width W of the frit 130 is larger than 5 mm, the non-display area would be larger unnecessarily with no more advantage. Meanwhile, if the thickness T of the frit 130 is smaller than 1 μm, then it would be difficult to apply the dispensing method, the screen-printing method, or the slit coating method to form the frit 130. On the other hand, if the thickness T of the frit 130 is larger than 3 mm, it would further be difficult to make the flat panel display thin. For example, the frit 130 has a width W of 1 mm through 2 mm, and a thickness T of 100 μm through 600 μm. The width W and the thickness T of the frit 130 can increase or decrease in proportion to the size of the flat panel display. Although the above description explains alternate embodiments of the invention, other embodiments of the invention include frits smaller than 0.1 mm and greater than 5 mm.

A surface of the frit 130 facing the insulating substrate 130 can be polished and planarized, thereby improving the adhesive uniformity and strength.

The frit 130 may include an adhesive powder and filler. The adhesive powder can include a metal oxide such as P₂O₅, V₂O₅, ZnO, BaO, Sb₂O₃, Fe₂O₃, Bi₂O₃, B₂O₃, SiO₂, TiO₂, PbO, PbTiO₃, and Al₂O₃, etc. The filler reduces a thermal expansion coefficient of the adhesive powder, and can be formed of an aluminum silicate such as spondumene, eucryptite, or cordierite. The frit 130 has a very low permeability of 1 g/m² to 10 g/m² to moisture and oxygen, so that the organic light emitting layer in the display element 110 is prevented from deteriorating. Further, the frit 130 has a sufficient durability to endure vacuum mounting, so that the OLED 1 can be fabricated in a vacuum chamber, thereby minimizing the permeability of oxygen and moisture from the outside. Thus, the lifespan of the flat panel display increases and the performance thereof is improved.

The sealant 150 can be formed of epoxy and functions to keep an alignment of the insulating substrate 100 and the cover substrate 120 while the substrates 100 and 120 are combined. The sealant 150 enhances coherence of the substrates 100 and 120 and reduces the contamination of the frit 130. The sealant 150 is optional.

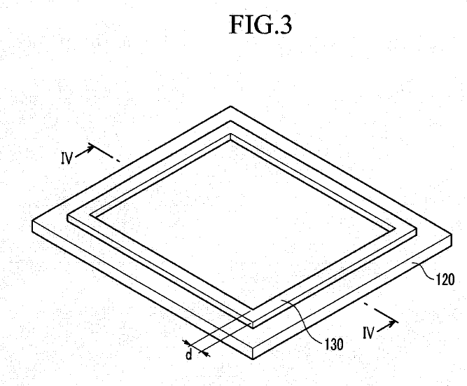

FIGS. 3 to 10 illustrate a method of manufacturing a flat panel display according to an exemplary of the present invention.

Referring to FIG. 3, a frit paste (not shown) is formed by mixing a frit powder with a binder and a solvent. The binder can be formed of cellulose based material such as ethyl cellulose, acryl based material such as poly methyl metacrylate (PMMA), or vinyl based material such as polyvinyl alcohol (PVA). The solvent can be formed of alcohol such as ethyl alcohol, hydrocarbon such as heptane, or glycolether acetate such as butyl cellosolve acetate.

The frit paste can be formed by a dispensing method, a screen printing method, a slit coating method, or a roll printing method.

Then, the solvent is removed by heating the frit paste to about 200° C. for about 10 min to about 20 min (Dry step). After the dry step, the binder is removed by heating the frit paste to about 400° C. to 500° C. for about 90 min to about 150 min (Calcination step), thereby forming the frit 130. By the calcination step, the adhesive strength between the particles of the adhesive powder is enhanced.

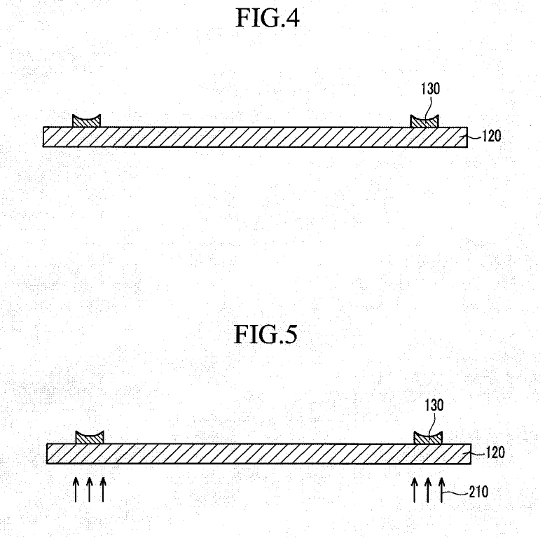

FIG. 4 is a sectional view taken along the line IV-IV of FIG. 3. In the event the frit 130 is formed by screen printing, the center surface of the frit 130 is concave as show in FIG. 4. Such a surface can cause a defect during the joining of the insulating substrate 100 and the cover substrate 120.

Generally, the adhesive powder includes plenty of moisture and hydroxyl. When hardening the frit 130 after joining the insulating substrate 100 and the cover substrate 120, moisture and hydroxyl emitted from the frit 130 can flow into to the display element 110 of FIG. 2, thereby causing the flat panel display to deteriorate.

When heating the frit to about 750° C., which is the general temperature for hardening the frit 130, very little hydroxyl within the internal space of the frit 130 is removed.

Referring to FIG. 5, the cover substrate 120 having the frit 130 disposed thereon is irradiated with a laser 210 to reduce the problem described above. In one embodiment, the laser 210 can be a diode laser having a wavelength of about 810 nm. The laser 210 is irradiated to a surface of the cover substrate 120 in the area corresponding and opposite to the frit 130. In another embodiment, the laser 210 can be irradiated to the cover substrate 120 through a laser mask (not shown). The irradiation of the laser 210 removes moisture and hydroxyl from the frit 130 and makes the frit 130 have fluidity. Moisture and hydroxyl is removed faster and more easily through the irradiation of the laser rather than through the use of heat.

Laser power, laser scan speed, and focal distance (i.e. distance between the laser head and the cover substrate) can be adjusted to control the temperature and melting rate of the frit according to the width and the thickness of the frit. In one embodiment, the laser power can be about 15 W to about 30 W, and the scan speed has a range of about 10 mm/sec to about 20 mm/sec.

The laser 210 can be irradiated in an atmosphere of inert gas such as N2 and Ar, or in a vacuum to prevent moisture in the atmosphere from re-adsorbing to or reacting with the frit 130.

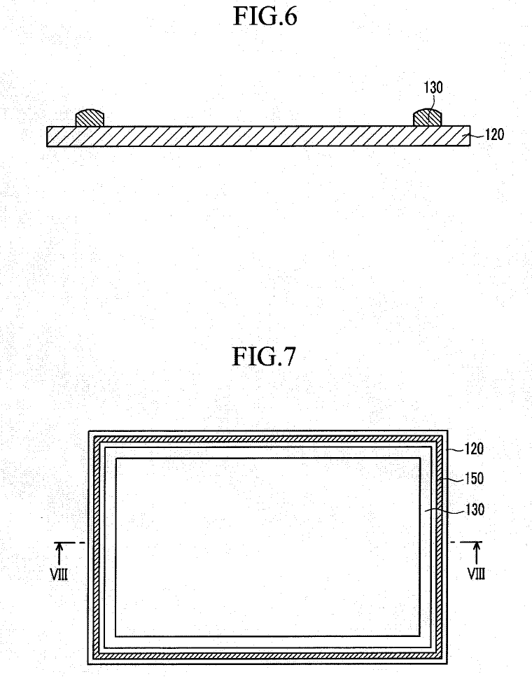

Referring to FIG. 6, after irradiating frit 130 with laser 210, the frit 130 has a convex center surface. In another embodiment, the projected surface of the frit 130 may be planarized.

Referring to FIG. 7, a sealant 150 is formed along the outside of the frit 130. The sealant 150 can be formed of epoxy. The width of the sealant 150 has a range of about 1 mm to about 5 mm.

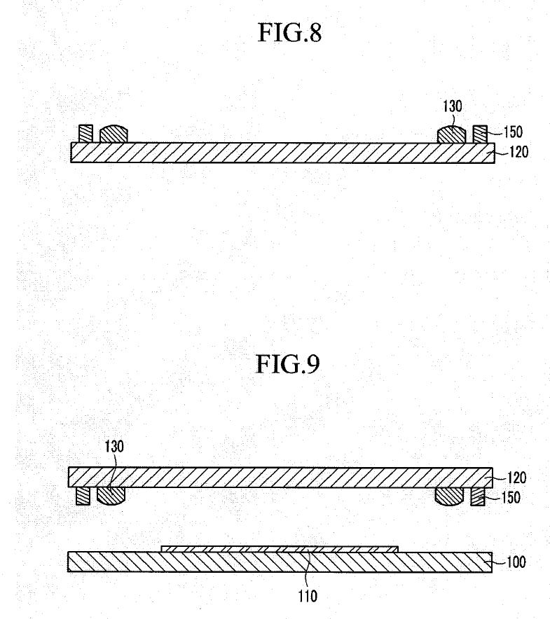

FIG. 8 is a sectional view taken along the line VII-VII of FIG. 7. In this embodiment of the invention, the thickness of the sealant 150 is substantially identical to the thickness of the frit 130.

FIG. 9 illustrates a process of aligning and combining the cover substrate 120 and the insulating substrate 100. Referring to FIG. 9, the two substrates 100 and 120 are aligned against each other with an align key (not shown) in the corners or the centers of the two substrates. After alignment, the pressure is applied to one of the two substrates 100 and 120, thereby making a contact of and combining two substrates 100 and 120 together by the sealant 150 interposed between the two substrates 100 and 120.

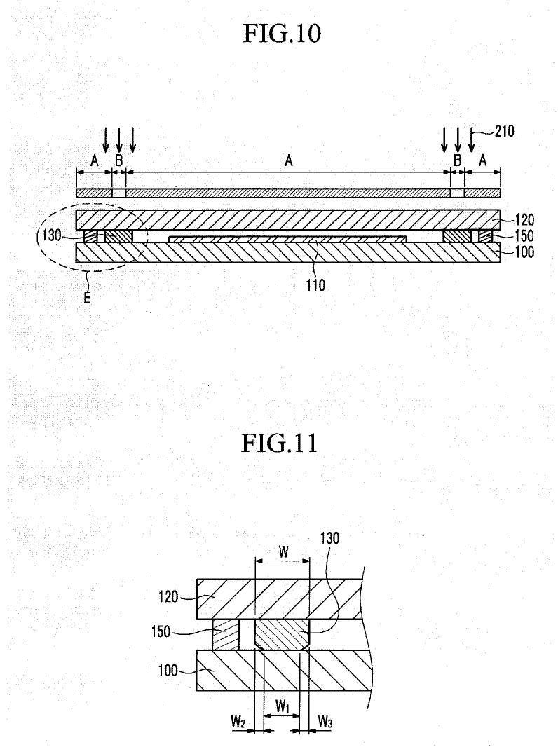

Referring to FIG. 10, the frit 130 is irradiated by a laser 210 through a laser mask 200 and the cover substrate 120, thereby fastening the cover substrate 120 to the insulating substrate 100 and completing the OLED of FIG. 1.

The laser mask 200 includes a base formed of quartz or soda lime glass, a non-transmissive area A and a transmissive area B. The non-transmissive area A is formed of copper Cu coated on the base, thereby reflecting the laser. Titanium Ti can be formed between the copper and the base to increase adhesiveness. The transmissive area B is disposed in the area corresponding to the frit 130. The width of the transmissive area B is identical to or less than the width of the frit 130, thereby reducing damage which can be caused by laser exposure to metal lines such as gate lines and data lines formed on the insulating substrate.

Since the frit 130 is almost melted and then hardened by the laser irradiation to join the two substrates 100 and 120, the laser intensity per unit area is stronger than the process described in FIG. 5. The laser intensity per unit area can be controlled by laser power, scan speed, or focal distance.

FIG. 11 is an enlarged detail view of the portion encircled by the dashed line “E” of FIG. 10. Referring to FIGS. 10 and 11, the frit 130 and the sealant 150 are interposed between the insulating substrate 100 and the cover substrate 120. Where the width of the transmissive area B is smaller than the width W of the frit, heat is transferred from the frit portion exposed to laser to the outside. The frit portion exposed to the laser can almost melt, but the outside area, i.e. the frit portion not exposed to laser, will hardly melt. Accordingly, the width W of the frit 130 includes a contact area W1 and non-contact areas W2 and W3 with the insulating substrate 100. The widths of W2 and W3 are substantially the same, and can be changed by the width of the transmissive area B, laser power, scan speed, or focal distance. Also, the surface of the frit 130 facing the insulating substrate 100 can have a convex shape toward the insulating substrate 100. In one embodiment, when the width of the frit 130 is 600 um and the width of the transmissive area B is 200 um, W2 and W3 are about 50 um.

In another embodiment of the invention frit 130 is a frit means for minimizing exposure of the display elements from outside contaminants. The frit means is interposed along an edge between the insulating substrate 100 and the cover substrate 120. The surface of the frit means facing the insulating substrate 100 includes a contact area W1 and non-contact areas W2 and W3 with the insulating substrate 100. Also, the surface can have a convex shape toward the insulating substrate.

As described above, the present invention provides a method of fabricating a flat panel display that can minimize inflow of moisture and hydroxyl emitted from the frit to the display element during the joining of the insulating substrate and the cover substrate.

Further, the present invention provides a flat panel display that can minimize the flow of moisture and hydroxyl emitted from the frit into the display element during the joining of the insulating substrate and the cover substrate.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of manufacturing a flat panel display comprising:
preparing a cover substrate;
forming a frit along an edge of the cover substrate;
irradiating a first laser to the cover substrate;
aligning and combining the cover substrate with an insulating substrate, the insulating substrate having a display element; and,
irradiating a second laser to the frit interposed between the cover substrate and the insulating substrate.

2. The method of claim 1, wherein the forming of the frit further comprises
forming a frit paste by mixing a frit powder, a binder and a solvent;
forming the frit paste along the edge of the cover substrate;
removing the solvent; and,
removing the binder.

3. The method of claim 2, wherein the frit paste is formed by a dispensing method, a screen printing method, a slit coating, or a roll printing method.

4. The method of claim 3, wherein the removing of the solvent is characterized with heating the frit paste about 150° C. to about 200° C. during about 10 min to about 20 min.

5. The method of claim 4, wherein the removing of the binder is characterized with heating the frit paste about 400° C. to about 500° C. during about 90 min to about 150 min.

6. The method of claim 1, wherein the first laser irradiation is characterized with irradiating the laser to the cover substrate corresponding to the area where the frit is formed.

7. The method of claim 6, wherein the first laser irradiation is formed in an atmosphere of an inert gas, or in a vacuum.

8. The method of claim 1, wherein a sealant is formed along the outside of the frit before the aligning and the combining of the cover substrate and the insulating substrate.

9. The method of claim 8, wherein the second laser is irradiated to the cover substrate through a laser mask.

10. The method of claim 9, wherein the laser mask comprises a transmissive part and a non-transmissive part.

11. The method of claim 10, wherein a width of the transmissive part is identical to or less than a width of the frit.

12. The method of claim 1, wherein the second laser intensity per unit area is stronger than the first laser intensity.

13. A flat panel display, comprising:
an insulating substrate having a display element disposed thereon;
a cover substrate facing and joined with the insulating substrate; and,
a frit interposed along an edge between the insulating substrate and the cover substrate, the frit including a frit surface facing the insulating substrate and having a first area in contact with the insulating substrate and a second area in no contact with the insulating substrate.

14. The flat panel display of claim 13, wherein the second area is in the outside of the first area.

15. The flat panel display of claim 14, wherein the frit surface has a convex shape toward the insulating substrate.

16. The flat panel display of claim 13, further comprising a sealant formed along the outside of the frit.

17. The flat panel display of claim 16, wherein the height of the sealant is substantially same as the height of the frit.

18. A flat panel display, comprising:
an insulating substrate having a display element disposed thereon;
a cover substrate facing and joined with the insulating substrate; and,
a frit means for minimizing exposure of the display elements from outside contaminants, the frit means interposed along an edge between the insulating substrate and the cover substrate, the frit means including a frit surface facing the insulating substrate and having a first area in contact with the insulating substrate and a second area in no contact with the insulating substrate.
